(19) United States
(12) Patent Application Publication
(10) Pub. No.: US 2026/0019739 A1
(43) Pub. Date: Jan. 15, 2026

(54) ACOUSTIC ABSORBERS FOR AUDIO SPEAKERS

(71) Applicant: Apple Inc., Cupertino, CA (US)

(72) Inventors: Reza GHAFFARIVARDAVAGH, San Jose, CA (US); Joshua A. COLTON, Cupertino, CA (US); Marco BARATELLI, San Francisco, CA (US); Matthew A. DONARSKI, San Francisco, CA (US); Onur I. ILKORUR, Santa Clara, CA (US)

(21) Appl. No.: 19/195,637

(22) Filed: Apr. 30, 2025

Related U.S. Application Data
(60) Provisional application No. 63/670,090, filed on Jul. 11, 2024.

(51) Int. Cl. H04R 1/28

(52) U.S. Cl. CPC H04R 1/288; H04R 1/2873; H04R 1/2888

(57) ABSTRACT

An absorber is positioned in a front volume of an audio speaker to minimize standing waves. An absorber may include a component that includes a channel with a length selected based on a characteristic (e.g., frequency) of the acoustical output of the audio speaker. Additionally, an absorber may include a resistive element to dampen the acoustical output of the acoustical output. Absorbers may be oriented horizontally or vertically in a front volume, and may be in a folded or fractal configuration.

### CROSS REFERENCE TO RELATED APPLICATION(S)

The present application claims the benefit of U.S. Provisional Application No. 63/670,090, entitled “ACOUSTIC ABSORBERS FOR AUDIO SPEAKERS”, filed Jul. 11, 2024, the entirety of which is incorporated herein for reference.

### TECHNICAL FIELD

This application is directed to audio speakers, and in particular, to acoustic absorbers that suppress certain vibrations that occur during operation of an audio speaker.

### BACKGROUND

Electronic devices may include one or more audio speakers (e.g., audio transducers) designed to generate an acoustical output (e.g., acoustical energy) in the form of audible sound. In some instances, during operation of the audio transducer, the acoustical output may create one or more standing waves in an enclosure of an audio speaker.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a perspective view of an embodiment of an audio speaker, in accordance with one or more aspects of the present disclosure.

FIG. 2 illustrates a side view of an embodiment of an absorber for audio speakers, in accordance with one or more aspects of the present disclosure.

FIG. 3, FIG. 4, and FIG. 5 illustrate side views of alternate embodiments of absorbers for audio speakers, in accordance with one or more aspects of the present disclosure.

FIG. 6 illustrates a perspective view of an alternate embodiment of an audio speaker, showing multiple absorbers in the audio speaker, in accordance with one or more aspects of the present disclosure.

FIG. 7 illustrates a graph showing several plots of sound pressure level (SPL) versus frequency for acoustic output of audio speakers with different configurations, in accordance with one or more aspects of the present disclosure.

FIG. 8A and FIG. 8B illustrate embodiments of electronic devices that include one or more audio speakers described herein, in accordance with one or more aspects of the present disclosure.

FIG. 9 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to audio speakers designed to minimize standing waves (e.g., eigenmodes) that may result, during operation of an audio speaker, in natural vibrations of an enclosure of the audio speaker in which the standing waves are located. The standing waves may cause frequency response peaks and frequency response dips in the measured SPL, particularly at higher frequency outputs of some audio speakers, such as smaller audio speakers for smaller electronic devices (e.g., earbuds, headphones). In order to minimize standing waves, audio speakers described herein may include one or more absorbers. An absorber may take the form of a resonator, which may be positioned in a front volume, or front volume enclosure, of the audio speaker. The absorber may include a tube positioned in the front volume and including a channel such that at least some of the acoustical output passes through the channel. The channel may include a length that is approximately equal to the wavelength of the acoustical output divided by 4 (e.g., one quarter or one fourth of the wavelength). In this regard, the absorber channel length may be selected to target a particular frequency (e.g., resonance frequency), and in some cases, a range of frequencies. Beneficially, absorbers described herein may minimize amplification of distortion by minimizing frequency response peaks, as well as minimize loss of output by minimizing frequency response dips.

Additionally, absorbers described herein may include a resistive element, such as a perforated plate (e.g., micro-perforated plate (MPP)) or a mesh material, either of which enhances dampening of the acoustical output by opposing the flow of the acoustical output. Based in part on the size of the pores (e.g., for an MPP) or the size of the openings of the mesh material, the resistive element may manage the amount of acoustical output dampened or dissipated.

Absorbers described herein may be oriented in a vertical or horizontal configuration. Additionally, at least some absorbers may be in a folded or fractal (e.g. tangled) configuration in order to fit with a relatively small front volume space. However, these absorbers may nonetheless minimize the standing waves by maintaining the channel length.

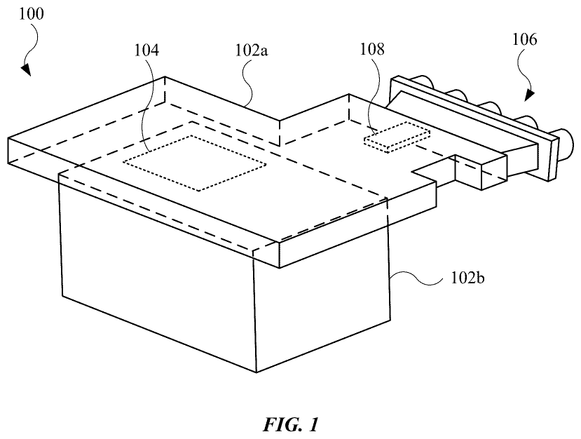

These and other embodiments are discussed below with reference to FIGS. 1-9. However, those skilled in the art will readily appreciate that the detailed description given herein with respect to these Figures is for explanatory purposes only and should not be construed as limiting.

FIG. 1 illustrates a perspective view of an embodiment of an audio speaker 100, in accordance with one or more aspects of the present disclosure. The audio speaker 100 is designed to generate an acoustical output in the form of audible sound. The audible sound may permeate through an environment via soundwaves. The audio speaker 100 may be integrated with a variety of consumer electronic devices, including mobile wireless communication devices (e.g., smartphones, tablet computing devices), audio devices (e.g., headphones, earbuds), and mixed reality (MR) devices (e.g., virtual reality (VR) devices, augmented reality (AR) devices).

The audio speaker 100 may include several volumes that define enclosures. For example, the audio speaker 100 may include a volume 102a and a volume 102b. In one or more implementations, the volume 102a and the volume 102b take the form of a front volume and a back volume, respectively.

The audio speaker 100 may further include a diaphragm 104. The diaphragm 104 may be driven (e.g., acoustically driven) to generate soundwaves. Although not shown, the audio speaker 100 may further include a voice coil and a magnet (e.g., permanent magnet), and the interaction between the voice coil, while receiving electrical current, and the magnet cause the voice coil to oscillate and acoustically drive the diaphragm 104. As shown, the diaphragm 104 is positioned in the volume 102a. However, the diaphragm 104 may be positioned between the volume 102a and the volume 102b.

The audio speaker 100 may further include a port 106. As shown, the port 106 may be defined by several openings. Alternatively, however, in one or more implementations, the port 106 may include a single opening. During operation of the audio speaker 100, at least some of the soundwaves generated by the diaphragm 104 exit the audio speaker via the port 106.

In some instances, at least some of the soundwaves may remain within the volume 102a. These soundwaves represent standing waves (e.g., eigenmodes) that may cause the volume 102a to vibrate. This may lead to issues such as distortion and/or loss of output. In order to minimize or eliminate the standing wave issue, the audio speaker 100 may include an absorber 108. The absorber 108 is designed to separate the standing waves in the volume 102a and dissipate the energy of the standing waves. This will be discussed further below.

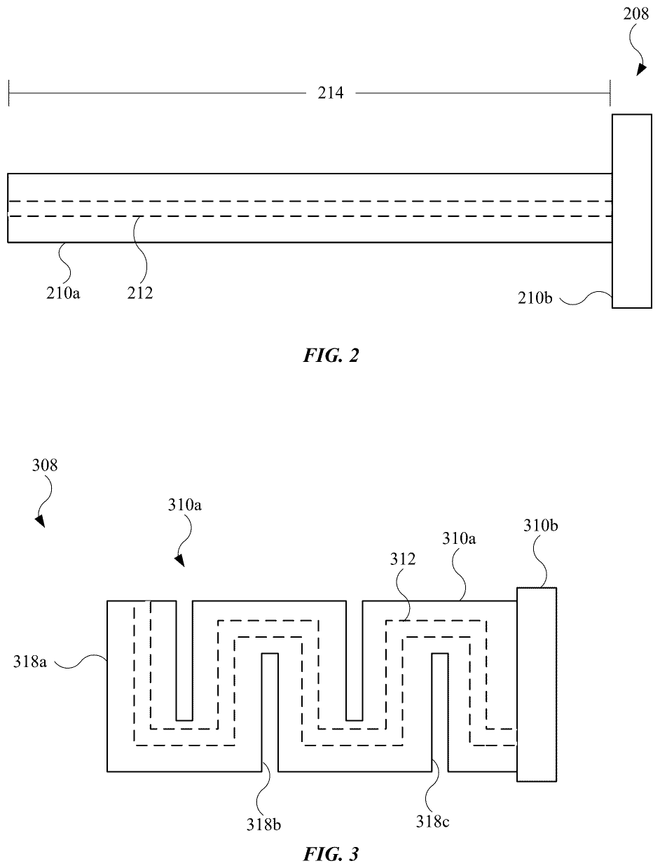

FIG. 2 illustrates a side view of an embodiment of an absorber 208 for audio speakers (e.g., audio speaker 100 shown in FIG. 1), in accordance with one or more aspects of the present disclosure. The absorber 208 may include several components. For example, the absorber 208 may include a component 210a and a component 210b. In one or more implementations, the component 210a takes the form of a tube designed to receive soundwaves generated by an audio speaker. In this regard, the component 210a may include a channel 212 that defines a hollow portion of the component 210a through which soundwaves are received. The component 210a may take the form of a resonator. As a result, the component 210a may vibrate based on soundwaves passing through the channel 212. The channel 212 may include a dimension 214 (e.g., length). In one or more implementations, the dimension 214 of the channel 212 is selected to target certain frequencies or frequency ranges. For instance, the dimension 214 can be designed such that targeted for the first resonance mode (1500 Hz-3000 Hz) and higher order modes (8000 Hz-16000 Hz). As shown, the component 210a is oriented horizontally, and may be horizontally oriented in an audio speaker. Alternatively, however, the component 210a may be oriented vertically in an audio speaker. In either orientation, the channel 212 takes the form of a straight channel, or linear channel. In one or more implementations, the channel 212 is tapered such that one end is wider than another, opposing end.

In order to tune the absorber 208 to a frequency of interest (e.g., resonance frequency), the dimension 214 of the component 210a may be selected to suppress standing waves at the frequency of interest. The speed of sound, v, (e.g., 343 meters/second) may be governed by the equation

$$v = f λ \qquad ( 1 )$$

where f is the selected frequency and λ is the wavelength, respectively, of the acoustic output. Rearranging Eq. (1), the wavelength λ can be derived as a function of the frequency f

$$λ = \frac{f}{v} . \qquad ( 2 )$$

In order to separate the soundwaves, the length L (e.g., dimension 214) of a channel (e.g., channel 212) may be a fraction of the wavelength λ. For example, the length L may be one fourth of the wavelength of the soundwave (of the acoustical output). Using Eq. (2), the length L may be expressed in terms as a function of the wavelength λ or as a function of the frequency f and the speed of sound v

$$L = \frac{λ}{4} = \frac{f}{4 v} . \qquad ( 3 )$$

By selecting the length L of the channel as indicated in Eq. (3), absorbers (e.g., the absorber 208) may provide suppression of standing waves within an audio speaker (e.g., within a front volume of an audio speaker). In one or more implementations, enhanced suppression may achieved by using a slightly mistuned absorber (e.g., absorber 208) where L is up to 15% larger or smaller that f/4v.

The component 210b may be acoustically coupled with the component 210a. As a result, at least some of the soundwaves passing through the component 210a may enter the component 210b, where the component 210b may dissipate at least some of the energy of the received soundwaves. In one or more implementations, the component 210b takes the form of a MPP. In this regard, the component 210b may include several pores having a diameter on the order of micrometers (e.g., 20 μm-200 micrometers). Alternatively, in one or more implementations, the component 210b takes the form of a mesh material having an acoustic impedance approximately in the range of 6 to 200 Rayls. In this regard, the component 210b may include several openings.

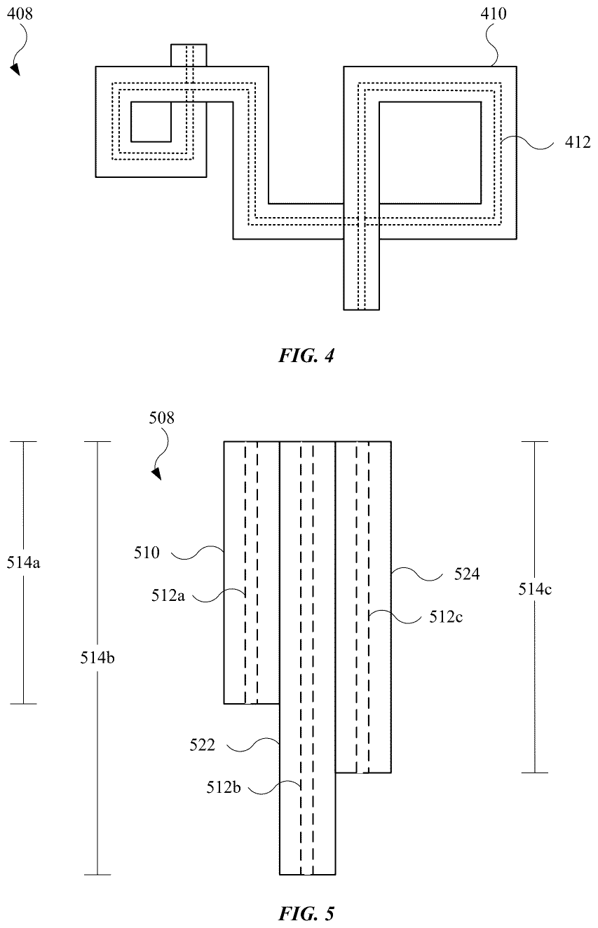

FIG. 3, FIG. 4, and FIG. 5 illustrate side views of alternate embodiments of absorbers for audio speakers, in accordance with one or more aspects of the present disclosure. Referring to FIG. 3, an absorber 308 includes a component 310a and a component 310b. The component 310a may include a channel 312. The component 310b may take any form of a component described for the component 210a (shown in FIG. 2).

As shown, the component 310a is folded. In this regard, the component 310a includes a portion 318a, a portion 318b, and a portion 318c. As shown, the portion 318a is folded over the portion 318b, and the portion 318b is folded over the portion 318c. Each of the portions 318a, 318b, and 318c may be representative of one or more additional portions.

Based on the component 310a taking the form of a folded component, the channel 312 may similarly take the form of a folded channel. However, the channel 312 may still retain a desired dimension, such as the dimension 214 of the channel 212 (shown in FIG. 2), and accordingly may still function to receive and suppress soundwaves entering the channel 312. In this regard, the length of the channel 312 allows the component 310a to suppress soundwaves in a manner similar to that of the component 210a (e.g., a straight component) shown in FIG. 2. Beneficially, the absorber 308 may occupy less volume within an enclosure (e.g., a front volume) of an audio speaker based on the folded configuration of the component 310a.

Referring to FIG. 4, an absorber 408 includes a component 410 with a channel 412. As shown, the component 410 make take the form of a fractal (e.g., tangled) component in which one or more portions of the component 410 are interweaved with each other. Similarly, the channel 412 may take the form of a fractal channel. Nonetheless, the channel 412 may still retain a desired dimension, such as the dimension 214 of the channel 212 (shown in FIG. 2), allowing the component 410 to suppress soundwaves in a manner similar to that of the component 210a (e.g., a straight component shown in FIG. 2). By providing the component 410 in a fractal configuration, the absorber 408 may be further manufactured to fit into smaller front volumes and/or front volumes with added complexities and geometries.

Referring to FIG. 5, an absorber 508 includes a component 510, a component 522, and a component 524. The component 510, the component 522, and the component 524 may include a channel 512a, a channel 512b, and a channel 512c, respectively. As shown, each of the components 510, 522, and 524 takes the form of a vertically oriented tube with different dimensions. In this regard, the channel 512a, the channel 512b, and the channel 512c may include a dimension 514a, a dimension 514b, and a dimension 514c, respectively, with the dimensions 514a, 514b, and 514c representing different dimensions. As a result, the absorber 508 may function to suppress standing waves at different frequencies, with each of the channels 512a, 512b, and 512c targeting different frequencies of standing waves based on their respective dimensions. The number of components (e.g., three components) of the absorber 508 is intended be exemplary, and several additional components may be included.

While the absorber 408 and the absorber 508 shown in FIG. 4 and FIG. 5, respectively, are shown as not including an additional component (e.g., the component 210b shown in FIG. 2), each of the absorbers 408 and 508 may include the additional component.

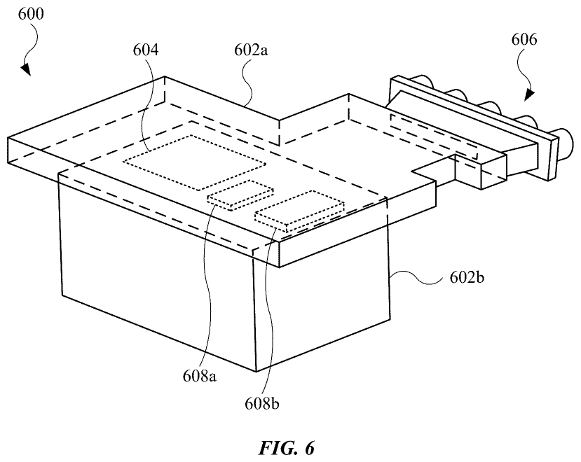

FIG. 6 illustrates a perspective view of an alternate embodiment of an audio speaker 600, showing multiple absorbers in the audio speaker 600, in accordance with one or more aspects of the present disclosure. As shown, the audio speaker 600 may include a volume 602a and a volume 602b that take the form of a front volume and a back volume, respectively, of the audio speaker 600. The audio speaker 600 may further include a diaphragm 604 that may be acoustically driven to generate soundwaves. The audio speaker 600 may further include a port 606 through which at least some of the generated soundwaves may exit the audio speaker 600.

The audio speaker 600 may further include an absorber 608a and an absorber 608b positioned in the volume 602a. As shown, the absorber 608a is separate, or separated, from the absorber 608b. Each of the absorbers 608a and 608b may take the form of any absorbers previously shown and/or described. Additionally, the absorbers 608a and 608b may be positioned in different locations in the volume 602a as compared to the position of the absorber 108 in the volume 102a (shown in FIG. 1). For example, each of the absorbers 608a and 608b may be located in a detected pressure maximum (e.g., sound-based pressure) in the volume 602a or located in multiple, detected local pressure maxima in the volume 602a. Additionally, based on their respective positions, the absorbers 608a and 608b may minimize standing waves at multiple eigenmodes. For example, one of the absorbers 608a and 608b may be positioned at or near the port 606 may minimize standing waves at a given frequency as well as at multiples of the given frequency.

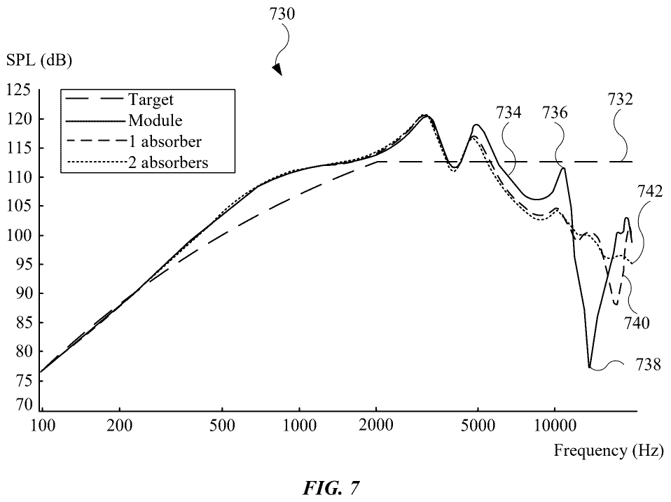

FIG. 7 illustrates a graph 730 showing several plots of SPL versus frequency for audio speakers with different configurations, in accordance with one or more aspects of the present disclosure. The SPL (on the Y-axis) is measured in decibels (dB) and the frequency (on the X-axis) is measured in Hertz (Hz). The graph 730 is shown as a logarithmic graph.

The graph 730 shows a plot 732 (Target) illustrating an ideal frequency response of an audio speaker generating soundwaves at different frequencies. The graph 730 further shows a plot 734 (Module) illustrating the frequency response of an audio speaker generating soundwaves without an absorber shown and/or described herein. As shown, at higher frequencies (e.g., on the order of 10 kHz), the plot 734 shows a peak 736 (e.g., frequency response peak) and a dip 738 (e.g., frequency response dip). When the frequency response includes a peak, issues such as distortion may be amplified. This may cause users to hear distorted audible sound. When the frequency response includes a dip, issues such as loss of output may occur. This may cause users to not hear audible sound at the intended volume.

The graph 730 further shows a plot 740 illustrating the frequency response of an audio speaker generating soundwaves with one absorber shown and/or described herein. As shown, the plot 740 illustrates a relatively smoother plot as compared to the plot 734, particularly as the frequency increases. In this regard, the absorber may be designed to target frequencies in a higher range by reducing peaks and dips in the frequency response.

The graph 730 further shows a plot 742 illustrating the frequency response of an audio speaker generating soundwaves with two absorbers shown and/or described herein. As shown, the plot 742 illustrates a relatively smoother plot as compared to the plot 740 (with one absorber), particularly as the frequency increases. Accordingly, adding an additional absorber may enhance the acoustical output of an audio speaker by further reducing peaks and dips in the frequency response.

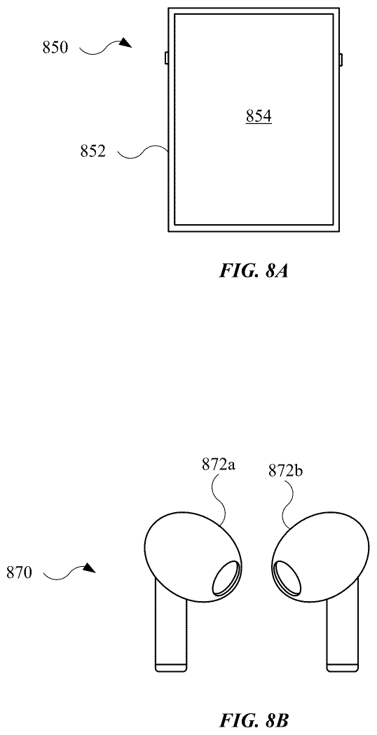

FIG. 8A and FIG. 8B illustrate embodiments of electronic devices that include one or more audio speakers described herein, in accordance with one or more aspects of the present disclosure. Each of the electronic devices shown in FIGS. 8A and 8B may include one or more audio speakers shown and/or described herein. Accordingly, each of the electronic devices shown in FIGS. 8A and 8B may include audio speakers with one or more absorbers.

Referring to FIG. 8A, an electronic device 850 takes the form of a mobile wireless communication device, such as a smartphone or a tablet computing device. The electronic device 850 may include a housing 852 and a display 854.

Referring to FIG. 8B, an electronic device 870 takes the form of earbuds, including an earbud 872a and an earbud 872b. Each of earbuds 872a and 872b may take the form of wireless earbuds. Alternative, the electronic device 870 may take the form of headphones (e.g., over-ear headphones), as a non-limiting example.

Alternatively, in one or more implementations, an electronic device with an audio speaker (or speakers) described herein may take the form of a head-mountable device, including an MR device, such as a VR device or an AR device. In this regard, the electronic device may include a housing and a display (representative of one or more displays). The electronic device may further include a band designed to fit on or around a user's head.

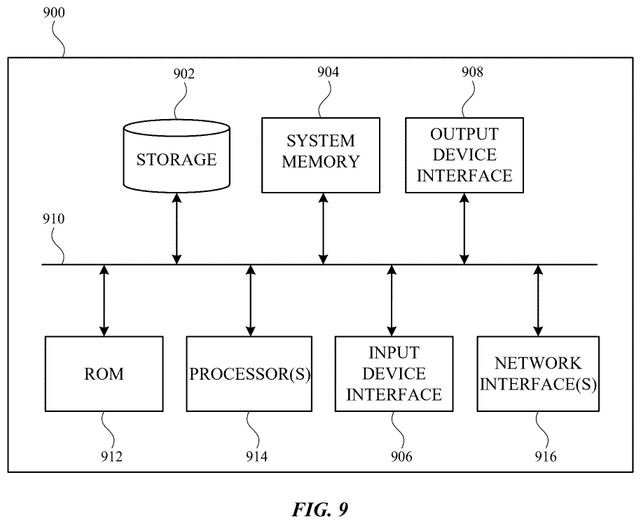

FIG. 9 illustrates an electronic system 900 with which one or more implementations of the subject technology may be implemented. The electronic system 900 can be, and/or can be a part of, the electronic devices 850 and 870 as shown in FIG. 8A and FIG. 8B, respectively. The electronic system 900 may include various types of computer readable media and interfaces for various other types of computer readable media. The electronic system 900 includes a bus 910, one or more processing units 914, a system memory 904 (and/or buffer), a ROM 912, a permanent storage device 902, an input device interface 906, an output device interface 908, and one or more network interfaces 916, or subsets and variations thereof.

The bus 910 collectively represents all system, peripheral, and chipset buses that communicatively connect the numerous internal devices of the electronic system 900. In one or more implementations, the bus 910 communicatively connects the one or more processing units 914 with the ROM 912, the system memory 904, and the permanent storage device 902. From these various memory units, the one or more processing units 914 retrieves instructions to execute and data to process in order to execute the processes of the subject disclosure. The one or more processing units 914 can be a single processor or a multi-core processor in different implementations.

The ROM 912 stores static data and instructions that are needed by the one or more processing units 914 and other modules of the electronic system 900. The permanent storage device 902, on the other hand, may be a read-and-write memory device. The permanent storage device 902 may be a non-volatile memory unit that stores instructions and data even when the electronic system 900 is off. In one or more implementations, a mass-storage device (such as a magnetic or optical disk and its corresponding disk drive) may be used as the permanent storage device 902.

In one or more implementations, a removable storage device (such as a flash drive, and its corresponding disk drive) may be used as the permanent storage device 902. Like the permanent storage device 902, the system memory 904 may be a read-and-write memory device. However, unlike the permanent storage device 902, the system memory 904 may be a volatile read-and-write memory, such as random access memory. The system memory 904 may store any of the instructions and data that one or more processing units 914 may need at runtime. In one or more implementations, the processes of the subject disclosure are stored in the system memory 904, the permanent storage device 902, and/or the ROM 912 (which are each implemented as a non-transitory computer-readable medium). From these various memory units, the one or more processing units 914 retrieves instructions to execute and data to process in order to execute the processes of one or more implementations.

The bus 910 also connects to the input device interface 906 and output device interface 908. The input device interface 906 enables a user to communicate information and select commands to the electronic system 900. Input devices that may be used with the input device interface 906 may include, for example, alphanumeric keyboards and pointing devices (also called “cursor control devices”). The input device interface 906 may enable, for example, the display of images generated by electronic system 900. Output devices that may be used with the input device interface 906 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 910 may also couple the electronic system 900 to one or more networks and/or to one or more network nodes through the one or more network interfaces 916. In this manner, the electronic system 900 can be a part of a network of computers (such as a LAN, a wide area network (“WAN”), or an Intranet, or a network of networks, such as the Internet. Any or all components of the electronic system 900 can be used in conjunction with the subject disclosure.

Various examples of aspects of the disclosure are described below as clauses for convenience. These are provided as examples, and do not limit the subject technology.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An absorber for an audio speaker, the absorber comprising:
a first component comprising a channel, the channel comprising a dimension based on an acoustical output of the audio speaker; and
a second component acoustically coupled with the first component, the second component configured to absorb at least some of the acoustical output that passes through the channel.

2. The absorber of claim 1, wherein the dimension comprises one quarter of a wavelength of the acoustical output.

3. The absorber of claim 1, wherein the channel is configured to dampen the acoustical output.

4. The absorber of claim 1, wherein the second component comprises a perforated plate.

5. The absorber of claim 4, wherein the perforated plate comprises a micro-perforated plate.

6. The absorber of claim 1, wherein the second component comprises a mesh material.

7. The absorber of claim 1, wherein the channel comprises:
a first portion; and
a second portion, wherein the first portion is folded over the second portion.

8. The absorber of claim 1, wherein the channel comprises a straight channel.

9. An audio speaker, comprising:
a diaphragm configured to generate an acoustical output;
a first volume; and
a first absorber positioned in the first volume and configured to dampen at least some of the acoustical output from the diaphragm, the first absorber comprising a first component that includes a first channel, the first channel comprising a first dimension based on a first wavelength of the acoustical output of the audio speaker.

10. The audio speaker of claim 9, wherein the first dimension comprises one quarter of the first wavelength of the acoustical output.

11. The audio speaker of claim 9, further comprising a second absorber comprising a second component, wherein:
the second component includes a second channel, the second channel comprising a second dimension based on a second wavelength of the acoustical output of the audio speaker,
the second dimension is different from the first dimension, and
the second wavelength is different from the first wavelength.

12. The audio speaker of claim 11, further comprising a second volume separate from the first volume, wherein the diaphragm is positioned in the first volume.

13. The audio speaker of claim 12, wherein:
the first volume comprises a front volume, and
the second volume comprises a back volume.

14. The audio speaker of claim 9, wherein the first absorber further comprises a second component acoustically coupled with the first component, the second component configured to absorb at least some of the acoustical output that passes through the first channel.

15. The audio speaker of claim 14, wherein the second component is selected from a perforated plate or a mesh material.

16. The audio speaker of claim 9, wherein the first channel comprises:
a first portion; and
a second portion, wherein the first portion is folded over the second portion.

17. An audio speaker, comprising:
a diaphragm configured to generate an acoustical output a first frequency and a second frequency different from the first frequency;
a first volume;
a first absorber positioned in the first volume and configured to dampen at least some of the acoustical output at the first frequency, the first absorber comprising a first channel that includes a first dimension based on the first frequency; and
a second absorber positioned in the first volume and configured to dampen at least some of the acoustical output at the second frequency, the second absorber comprising a second channel that includes a second dimension based on the second frequency.

18. The audio speaker of claim 17, further comprising a second volume, wherein:
the first volume comprises a front volume, and
the second volume comprises a back volume.

19. The audio speaker of claim 17, wherein:
the first channel comprises a first folded channel, and
the second channel comprises a second folded channel.

20. The audio speaker of claim 17, wherein the first absorber is separate from the second absorber.
